(19) United States
(12) Patent Application Publication
(10) Pub. No.: US 2010/0206334 A1
(43) Pub. Date: Aug. 19, 2010

(54) Method for cleaning a reactor

(76) Inventors: Peter Fritz, Unterhaching (DE); Heinz Bölt, Wolfratshausen (DE); Fuad Mosa, Riyadh (SA); Talal Ali, Riyadh (SA); Abdullah Al Dugaither, Riyadh (SA)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/989,916

(22) PCT Filed: Jun. 13, 2006
(86) PCT No.: PCT/EP2006/005644

§ 371 Date: Apr. 19, 2010

(30) Foreign Application Priority Data
Aug. 10, 2005 (EP) 05017338.4

(51) Int. Cl. B08B 7/00

(52) U.S. Cl. 134/19

(57) ABSTRACT

The present invention relates to a method for cleaning a reactor having a tendency of fouling by deposition of solids, wherein a hot solvent, in which the solids are soluble and which has a temperature of at least about 75° C., is applied to the reactor, the solids being substantially dissolved and the dissolved solids being discharged from the reactor, wherein the method is carried out without opening the reactor to atmosphere.

The present invention relates to a method for cleaning a reactor having a tendency of fouling by deposition of solids.

Reactor fouling is especially a problem related to polymer technologies, i.e. oligomerisation and polymerisation reactions, for example the polymerisation of polypropylene, polyethylene, polystyrene and the like.

As a consequence of “fouling”, the reactor has to be cleaned periodically, and, preferably, a spare reactor is required.

For cleaning of the reactor having solids (e.g. high molecular weight oligomers/polymers) deposited, the reactor has to be opened, and plant personnel has usually to enter the reactor for cleaning thereof mechanically. After cleaning, the reactor has usually to be inertised to be ready for a further oligomerisation or polymerisation reaction.

A typical reactor downtime for cleaning is about 1 week. Thus, a cleaning operation adds to the costs of the product to be produced.

Therefore, it is an object of the present invention to provide a method for cleaning a reactor having a tendency of fouling by deposition of solids, which method overcomes the disadvantages of the prior art. Especially a method shall be provided which does not require mechanical cleaning, reduces the reactor down time, does not require purging/inertizing before/after cleaning and improves plant safety.

This object is achieved in that a hot solvent, in which the solids are soluble, and which has a temperature of at least about 75° C., is applied to the reactor, the solids being substantially disolved and the dissolved solids being discharged form the reactor, wherein the method is carried out without opening the reactor to atmosphere.

Surprisingly, it was found that using the inventive method for cleaning a reactor, no mechanical cleaning is necessary and the reactor downtime for cleaning is significantly reduced. Further, no purging/inertizing of the reactor before/after cleaning is necessary any longer as the reactor has not to be opened. Also, an automatic cleaning procedure may be provided by a sequence control, and the need of a spare reactor is eliminated. Finally, the plant safety is improved, since no plant personnel has to enter the reactor for cleaning and the risk of hydrocarbon exposure to atmosphere is eliminated.

The term “reactor”, as used herein, is not only related to the reaction vessel as such, but encompasses all equipments connected to the reaction vessel, such as pipes, supply vessels, distillation columns and the like. Someone skilled in the art is therefore aware of the necessary equipments which are included in the term “reactor”. The inventive method may be applied to all chemical reactors which have a tendency of fouling by deposition of solids, especially to polymer technologies, such as a polymerisation of polypropylene, polyethylene or polystyrene.

It is preferred that the reactor is an oligomerisation or polymerisation reactor.

Most preferably, the reactor is an oligomerisation reactor for the oligomerisation of ethylene to obtain linear alpha-olefins.

Preferably, the solvent is an organic solvent, more preferably a hydrocarbon solvent.

The solvent may be selected from toluene, xylenes, benzene or mixtures thereof. Toluene is the most preferred solvent.

In one aspect the dissolved solids are transferred to a solvent recovery unit.

In a further aspect the solvent may be recovered by distillation, crystallization, thin-film evaporation, whiped-film evaporation and/or falling-film evaporation.

In a preferred embodiment the solvent is heated by external heating and/or within the reactor by means of runaway of a reaction carried out therein.

More preferably, the external heating is provided by a heat exchanger.

The inventive method is preferably applied to the reactor immediately after the process regularly carried out in that reactor has been finished. Preferably, the inventive method may be utilized in an oligomerisation reactor for the oligomerisation of ethylene to obtain linear alpha-olefins. After having finished the oligomerisation reaction, hot solvent, preferably hot toluene, having a temperature of about 100 to 130° C., is introduced into the reactor and its equipment. In an alternative the solvent may be heated after introduction into the reactor. The hot toluene is then distributed throughout the reactor and its equipment to dissolve the solid deposits, especially high molecular weight oligomeric/polymeric deposits on the reactor walls. As the deposits are soluble in hot toluene, they may be discharged from the reactor easily by discharging the toluene. The solids dissolved in hot toluene may be then transferred to a solvent recovery unit, such as a distillation column, to separate the dissolved solid from the solvent. The solvent may then be recycled into the reactor for further cleaning thereof, or may be stored for further use.

Due to its unique solubility for high molecular weight oligomers/polymers, toluene is the most preferred solvent for use in oligomerisation and polymerisation reactors.

The features disclosed in the foregoing description or in the claims may, both separately and in any combination thereof, be material for realizing the invention in diverse forms thereof.

1. A method for cleaning deposits of high molecular weight oligomers from an oligomerization reactor characterized in that a solvent selected from the group toluene, xylenes, benzene, or mixtures thereof, is introduced into the reactor and distributed throughout it at a temperature of at least 75° C. until the high molecular weight oligomers deposited in the reactor are dissolved, the solvent containing the dissolved oligomers is then discharged from the reactor, wherein the method is carried out without opening the reactor to atmosphere.

2. (canceled)

3. The method according to claim 1, wherein the reactor is an oligomerisation reactor for the oligomerisation of ethylene to obtain linear alpha-olefins.

4. (canceled)

5. The method according to claim 3, wherein the solvent comprises toluene.

6. The method according to claim 5, wherein the solvent is distributed through out the reactor at a temperature in the range of about 100° C. to about 130° C.

7. The method according to claim 1, wherein the solvent containing dissolved oligomers is transferred to a solvent recovery unit after cleaning the reactor.

8. The method according to claim 7, wherein the solvent is recovered by distillation, crystallization, thin-film evaporation, wiped-film evaporation and/or falling-film evaporation.

9. The method according to claim 1, wherein the solvent is heated by external heating and/or within the reactor by means of a reaction carried out therein.

10. The method according to claim 9, wherein the external heating is provided by a heat exchanger.
